(19) United States
(12) Patent Application Publication
(10) Pub. No.: US 2026/0359247 A1
(43) Pub. Date: Nov. 12, 2026

(54) METHOD FOR ASSIGNING UNIQUE ADDRESSES TO TARGET ICS

(71) Applicant: Robert Bosch GmbH, Stuttgart (DE)

(72) Inventors: Jens Goldeck, Reutlingen (DE); Xiaowei Feng, Frankfurt A.M. (DE)

(21) Appl. No.: 19/665,251

(22) Filed: May 1, 2026

(30) Foreign Application Priority Data
May 9, 2025 (DE) 10 2025 117 879.8

(51) Int. Cl. G06F 13/40; G06F 13/24; G06F 13/42

(52) U.S. Cl. CPC G06F 13/404; G06F 13/24; G06F 13/4282

(57) ABSTRACT

A method and device for assigning unique addresses to target ICs that are connected via a common address-based serial bus to a host IC, wherein the host IC is connected to the target IC via associated dedicated control lines, and wherein the target ICs have a common default bus address after a reset. The method includes: sending at least one configuration command by the host IC via the serial bus to the common default bus address, thereby placing the target ICs connected to the serial bus into a configuration mode; sending an address message by the host IC via the corresponding control line to at least one target IC in the configuration mode, whereupon the target IC derives, from the received address message, its own individual bus address, which replaces the previous default address.

### CROSS REFERENCE

The present application claims the benefit under 35 U.S.C. § 119 of Germany Patent Application No. DE 10 2025 117 879.8 filed on May 9, 2025, which is expressly incorporated herein by reference in its entirety.

### FIELD

The present disclosure relates to a method and a device for assigning unique addresses to target ICs that are connected via a common address-based serial bus to a host IC.

### BACKGROUND INFORMATION

Communication between different integrated electronic components (ICs) at printed circuit board level often takes place via serial interfaces such as I2C, I3C, SPI, wherein a bus host has control over such a serial bus. U.S. Patent Application Publication No. US 2014/153681A1 describes an I2C interface comprising a data line and a clock line.

To conserve resources, i.e., circuit board space, pins on the host IC, and similar resources, a plurality of target ICs are often connected to a single bus. There are various conventional mechanisms to ensure unambiguous communication in this case.

In a chip-select mechanism, the addressed target IC is addressed via a dedicated control line, wherein a control line extends from the host IC to each target IC. The host IC signals to each target IC via the associated control line whether the target IC in question is to be addressed or not. The chip-select mechanism is used, for example, in an SPI bus. The chip-select mechanism is configured for simple addressing and requires no address management. Furthermore, a plurality of identical ICs can be operated on a single bus. However, if there are many bus users, the chip-select mechanism leads to a correspondingly high number of required control lines and pins on the host IC. The number of pins required on the target ICs is also higher.

In a conventional addressing mechanism, each target IC is assigned a logical static bus address. At the beginning of a serial message, all target ICs listen, but do not influence the bus (data lines are in logical “tri-state”). The first part of a message transmitted on the serial bus contains the destination address of a desired target IC. Each target IC compares the address contained in the message with its own address, and only the selected target IC then responds to the message received from the host IC. Such a conventional addressing mechanism is used, for example, in an I2C bus, as shown in FIG. 1A. The I2C bus comprises two cables. The SDA (Serial Data) line is the data line via which the data are transmitted. The SCL (Serial Clock) line is also referred to as the clock line and specifies the clock frequency. All target ICs shown in FIG. 1A have an individual static default address. Each target IC requires a unique address, which it must know immediately after power-on, since communication outside the bus is not provided. This unique address is also referred to as the default address. It is not possible to have two target ICs with the same default address. Furthermore, in the conventional addressing mechanism, the number of pins remains constant and does not increase with the number of target ICs connected to the bus.

However, using a conventional addressing mechanism entails some disadvantages. The individual messages are longer because the destination address must be included. The three target ICs shown in FIG. 1A, T-IC_{A}, T-IC_{B}, T-IC_{C} each have a unique address or default address (0x10, 0x20, 0x30). This makes it more difficult to use a plurality of identical ICs on the same bus. However, in this case, only two addresses are supported, and some ICs cannot provide an additional hardware pin due to packaging constraints.

In a conventional dynamic addressing mechanism, a plurality of target ICs start with the same address. The host IC uses a special command to request the target ICs to assume a specific address. The target IC that wins the bus arbitration on the basis of a provisional ID receives confirmation, and all other target ICs terminate the process. This process is repeated until all target ICs have an address. A dynamic addressing mechanism is used, in some cases, in an I3C bus.

However, the dynamic addressing mechanism is not deterministic. It is not defined which target IC receives which address. In the case of identical sensors installed in specific locations within a final product, where it is relevant for the application to identify which sensor delivers which values, this method results in the host IC not knowing exactly which sensor has received which address. Dynamic addressing also fails if a plurality of target ICs have the same provisional ID. This can often occur when the target ICs are of the same component type.

The default address is usually already defined when the target ICs are delivered. Therefore, address conflicts can easily occur, in particular when two identical ICs are used on one bus.

Therefore, manufacturers have provided various mechanisms for changing the default address. As a rule, the technical standards for serial buses do not require a regulatory authority. However, in certain niche applications, such as automotive applications, there is an allocation of address spaces according to manufacturers and products. In some sectors, uncoordinated address allocations have become established.

In some target ICs, the default address can be stored in a non-volatile memory, so that either the manufacturer of the target IC or the installer of the target IC can change the default address before the target IC is installed in a product. However, this is generally complex and requires further manufacturing steps. The manufacturer of the target IC may then need to provide different product variants and provide logistical support. The assembler of the target IC may need to contact the target IC in question again before soldering and change the default address. The assembler must ensure that the identical target ICs, which are visually indistinguishable, are correctly installed in the product with different default addresses.

Some target ICs offer the possibility of influencing the least significant bit of the address by means of a dedicated pin that is hardwired either to the power supply or to ground on the printed circuit board. This allows two default addresses for one component type to be obtained through simple integration into the printed circuit board layout.

Since bus communication in a host-target bus can only be initiated by a host IC, there are many applications in which an interrupt line INT is routed directly from an output OUT of a target IC to the input INP of the host IC. As a result, a target IC can inform the host IC about events, wake the host IC up, and request specific actions, as shown schematically in FIG. 1B for the target IC T-IC_{B}. The interrupt line INT is not required for bus communication, but can be used for other functions, for example for event interrupts.

### SUMMARY

According to a first aspect, the present disclosure provides a method for assigning unique addresses to target ICs connected to a host IC via a common serial bus, wherein the host IC is connected to the target ICs via associated dedicated control lines, and wherein the target ICs have a common default bus address after a reset. According to an example embodiment, the method comprises the steps of:
sending at least one configuration command by the host IC via the serial bus to the common default bus address, thereby placing the target ICs connected to the serial bus into a configuration mode;
sending an address message by the host IC via the corresponding control line to at least one target IC in the configuration mode, whereupon the target IC derives its own individual bus address from the received address message; and
sending a command by the host IC via the serial bus to the common default bus address to terminate the configuration mode, thereby causing the target ICs connected to the serial bus to terminate the configuration mode and change the default bus address to their respective individual bus addresses.

In one possible example embodiment, the configuration command KONB may comprise a sequence of commands or may be a longer data stream.

The serial bus is an address-based serial bus, i.e., a serial bus having address-based interfaces to the target ICs. The address-based serial bus is, for example, a UART, LIN, or CAN. In contrast, SPI or SENT, for example, are also serial buses, but do not have address-based interfaces to target ICs of which the address can be changed.

The method according to the present disclosure relates to any serial bus connections that use target addressing. The present method according to the present disclosure opens up the possibility of using target ICs having the same default bus address on a serial bus and being able to address them uniquely with different addresses after a configuration phase. Communication via the serial bus remains protocol-compliant at all times.

For this purpose, the target ICs are configured to be able to change their bus address upon request from the host IC. In this way, all target ICs with the same address are simultaneously placed into a configuration mode, and each of the target ICs is then sequentially signaled via a control line to change its address. Once this configuration is complete, all target ICs can be uniquely addressed via their changed bus addresses.

The method according to the present disclosure comprises a combination of an additional functionality in the target IC and the provision of a specific sequence during the configuration phase of the system after a successful startup. The host IC can generally be installed without modification.

A significant advantage of the method according to the present disclosure is that communication via the serial bus remains protocol-compliant at all times.

The method according to the present disclosure allows for the unique addressing of a plurality of target ICs connected to the serial bus and having the same initial default address.

This offers the advantage that the different addresses do not need to be taken into account in the printed circuit board layout.

The method according to the present disclosure has the further advantage that no additional pin is required during regular operation. Only during the configuration phase is the use of a separate pin on the target IC required.

The method according to the present disclosure offers the further advantage that no additional resource consumption occurs if the configuration pin is subsequently used for another purpose (for example, as an interrupt pin) during operation.

The method according to the present disclosure not only works with two target ICs having the same initial default address, but can be scaled as desired.

The use of the method according to the present disclosure allows or greatly simplifies the installation of identical ICs on the same serial bus on a printed circuit board.

In the method according to the present disclosure, the changed or newly assigned bus addresses of the target ICs are also deterministic.

In one possible example embodiment of the method for assigning unique addresses to target ICs, after the host IC sends the address message via the serial bus, a termination command is sent to the common default bus address to terminate the configuration mode, causing the target ICs connected to the serial bus to leave the configuration mode and change their previous default bus address in each case to the individual bus address derived from the received address message.

In a possible alternative example embodiment of the method for assigning unique addresses to target ICs, after a predetermined time period following the receipt of the configuration command by a target IC, the target IC is caused to automatically leave the configuration mode and change its previous default bus address in each case to the individual bus address derived from the received address message. This example embodiment offers the advantage that the host IC does not need to send a termination command to terminate the configuration mode.

In one possible example embodiment of the method according to the present disclosure for assigning unique addresses to target ICs, the individual bus address derived from the received address message is stored locally in a non-volatile memory of the target IC and is used as the default address of the target IC upon a restart.

In one possible example embodiment of the method for assigning unique addresses to target ICs, the address message transmitted by the host IC to a target IC via the associated control line has signal edges, the number of which is evaluated by the target IC in order to derive its individual bus address. This allows a simple and robust implementation.

In one possible embodiment of the method according to the present disclosure for assigning unique addresses to target ICs, the address message transmitted by the host IC to a target IC via the associated control line is transmitted using a Manchester code.

In one possible embodiment of the method according to the present disclosure for assigning unique addresses to target ICs, the target ICs connected to the serial bus are placed into a configuration mode by the host IC simultaneously or sequentially.

In one possible example embodiment of the method according to the present disclosure for assigning unique addresses to the target, the host IC has a plurality of GPIO pins, each of which is connected to input pins of the target ICs via associated control lines. The control lines can be formed using existing interrupt lines, such that no additional implementation effort is required.

In one possible example embodiment of the method according to the present disclosure for assigning unique addresses to target ICs, the host IC configures the relevant GPIO pin as an output pin before sending an address message to a target IC via a control line.

In one possible example embodiment of the method according to the present disclosure for assigning unique addresses to target ICs, the host IC configures the relevant GPIO as an input pin after changing the bus address of the target IC. This allows the control line in question to be used again as an interrupt line.

In one possible example embodiment of the method for assigning unique addresses to target ICs, the target ICs connected to the serial bus each contain a bus address configurator which, after the configuration command is received by the target IC in question, is automatically activated to perform an address change of the bus address in accordance with the address message received via the control line of the target IC. The bus address configurator may be implemented by a hardware component or by a software component of the target IC.

According to a further aspect of the present disclosure, a bus address configurator is provided for configuring a unique bus address for a target IC, which is connected to a host IC via an address-based serial bus and via a dedicated control line, wherein the bus address configurator of the target IC is activated following receipt of at least one configuration command transmitted via the serial bus and changes a previous default address of the target IC to an individual bus address for the target IC, which is derived by the bus address configurator of the target IC from an address message received via the dedicated control line.

According to another aspect, the present disclosure provides a target IC having a bus address configurator according to the present disclosure and having a non-volatile memory for storing the changed individual bus address as the new default address of the target IC.

In one possible example embodiment of the target IC according to the present disclosure having a bus address configurator, the target IC comprises a sensor IC having at least one sensor unit.

In one possible example embodiment of the target IC according to the present disclosure having a bus address configurator, the sensor IC comprises an inertial sensor IC. The inertial sensor can measure changes in linear acceleration and angular velocity of a vehicle or other apparatus.

The above example embodiments and developments may be combined with one another in any reasonable manner. Further possible embodiments, developments and implementations of the present disclosure also include combinations not explicitly mentioned of features of the present disclosure described above or in the following relating to the exemplary embodiments. In view of the present disclosure, a person skilled in the art will in particular also add individual aspects as improvements or additions to the relevant basic form of the present disclosure.

The present disclosure is explained in more detail below on the basis of the exemplary embodiments indicated in the schematic figures.

Possible example embodiments of the device according to the present disclosure and of the method according to the present disclosure are described in more detail below with reference to the figures.

### BRIEF DESCRIPTION OF THE DRAWINGS

FIGS. 1A, 1B are diagrams illustrating conventional addressing methods.

FIG. 2 is a flowchart illustrating an exemplary embodiment of the method according to the present disclosure for assigning unique addresses to target ICs.

FIG. 3-7 are diagrams illustrating the mode of operation of the method according to the present disclosure for assigning unique addresses to target ICs.

### DETAILED DESCRIPTION OF EXAMPLE EMBODIMENTS

The figures are intended to impart further understanding of the example embodiments of the present disclosure. They illustrate embodiments and, in connection with the description, serve to explain principles and concepts of the present disclosure. Other embodiments and many of the mentioned advantages are apparent from the figures. The elements of the figures are not necessarily shown to scale relative to one another.

In the figures, identical, functionally identical, and identically acting elements, features and components are provided with the same reference signs in each case, unless stated otherwise.

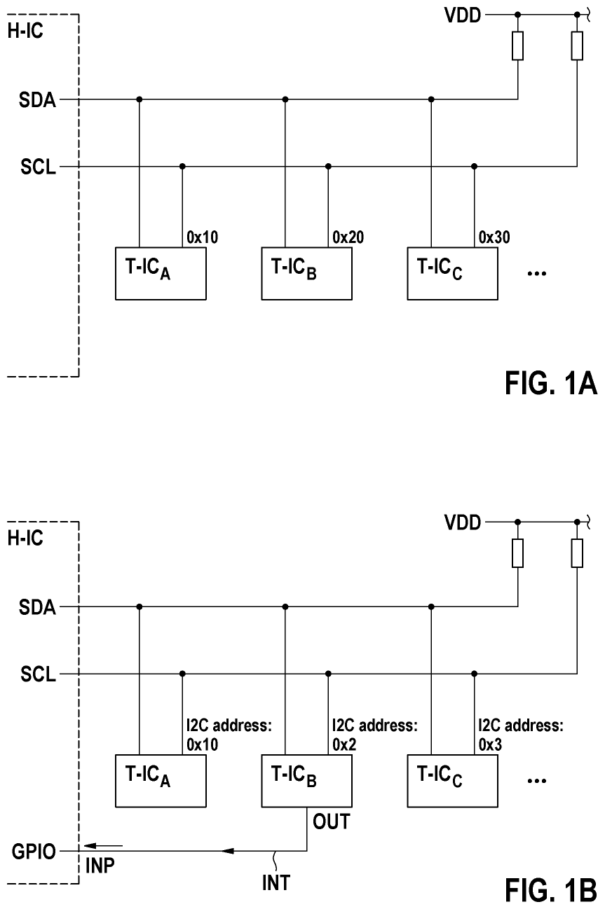

When conventional mechanisms between a host IC and target ICs are used, as shown in FIG. 1A and FIG. 1B, usual bus wiring is provided between the target ICs and the host IC. For this purpose, a control line may be provided for each target IC, extending from a digital output pin of the host IC and leading to a digital input pin of the target IC. This control line is already present in many cases as the interrupt line INT, but the interrupt line is used functionally in reverse, i.e., it connects a digital output of the target IC to a digital input of the host IC in order to be able to send an interrupt from the target IC to the host IC, as shown schematically in FIG. 1B for the _{target}-IC T-IC_{B}. Since digital pins are generally freely configurable as input or output, the same pin can nevertheless usually be used in the method according to the present disclosure. For this purpose, both pins located at both ends of the control line must be configured at all times according to the process according to the present disclosure. The digital outputs of the host IC are referred to in the following description as “GPIO pin” (General Purpose Input Output pin).

After a successful system startup, each target IC listens to a defined default address (i.e. bus address=default address). The bus address of a target IC can be changed using the method according to the present disclosure. In one possible embodiment, the bus address of a target IC is changed by writing to internal registers of the target IC.

The target ICs are connected to a host IC via a serial bus. The serial bus may, for example, be an I2C bus having a serial data line SDA and a clock line SCL, as shown in FIG. 3 to 7. The method according to the present disclosure can also be used for other types of serial buses having address-based interfaces, for example for I3C, UART, LIN, CAN, PSI5, FlexRay, MSC or Ethernet.

In one possible embodiment, a bus address configurator is provided in the target IC. The target IC is adapted to respond to a KONB configuration command received via its serial interface and to start its bus address configurator. In one possible embodiment, the bus configurator is a digital circuit integrated into the target IC. In one possible embodiment, the configuration command KONB may also be a sequence of commands or a longer data stream.

The target IC has (at least) one digital pin that functions as an input and is referred to hereinafter as the “INT pin.” The target IC's bus address configurator has access to this digital pin and the capability of changing the target IC's bus address.

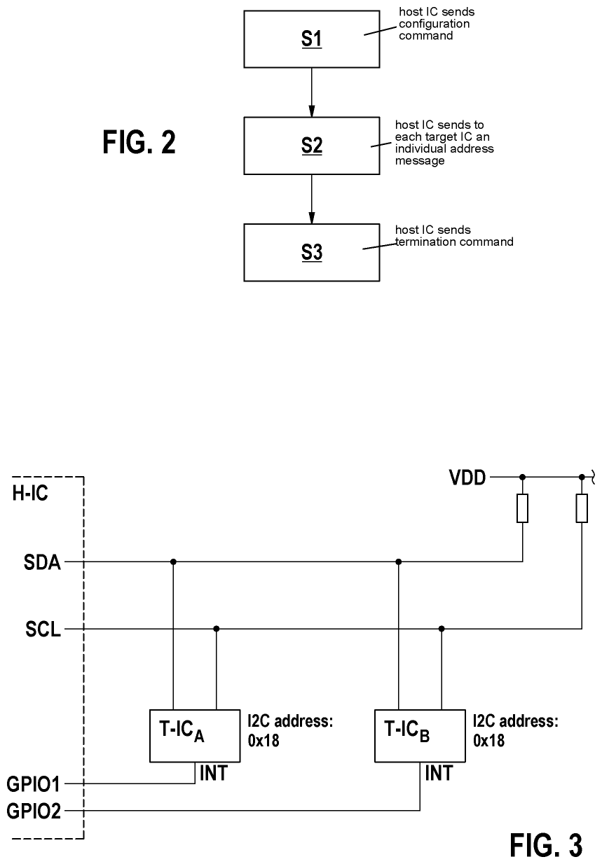

In the method according to the present disclosure shown schematically in FIG. 2, after a (power-on) reset, the target ICs T-ICs initially start with their default address and the INT pins of the target ICs are each configured as inputs, as shown in FIG. 3 for target ICs TC-IC_{A} and TC-IC_{B}. The host IC configures each of its GPIO pins, which are connected to the INT pins of the target ICs, as outputs. As shown in FIG. 3, both target ICs TC-IC_{A} and TC-IC_{B} have the same default address (in this example 0x18).

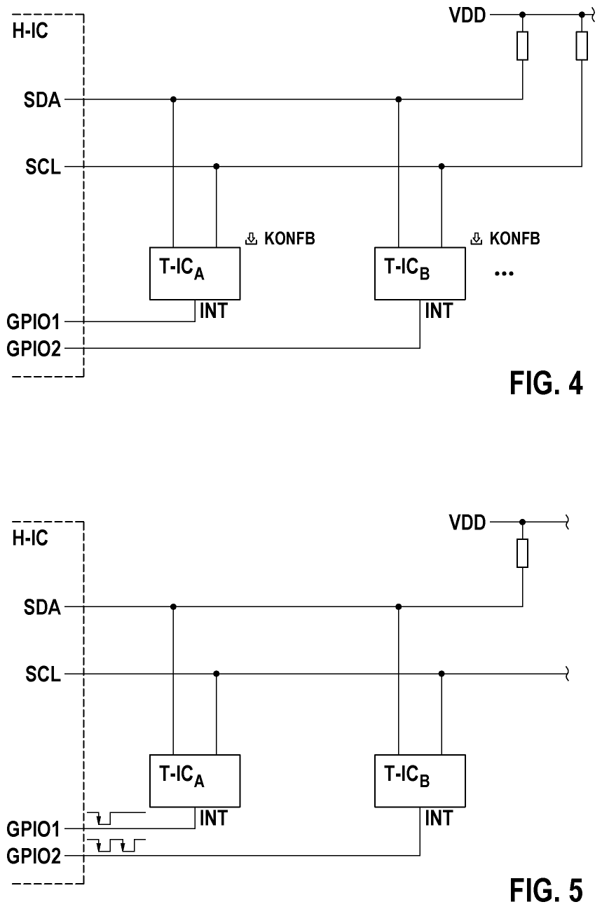

In a first step S1, the host IC sends a configuration command KONFB (write) via the serial bus to the default address, as shown in FIG. 4. All target ICs accept the KONFB configuration command, send no response and automatically enter KMOD configuration mode, i.e. the bus address configurator of each target IC is activated.

In a second step S2, the host IC now sends, via the GPIO pins configured as outputs and via the control lines, to each target IC an individual address message corresponding to the desired bus address of that target IC. The target IC receives the address message and determines its future bus address therefrom. The target IC can derive its future bus address from the address message received in step S2.

In one possible example embodiment, the host IC subsequently sends, in a third step S3, a termination command to terminate the KMOD configuration mode (write) to all target ICs at the default address. In this embodiment, all target ICs accept the received termination command, do not send a response and, in accordance with the previously received address message, change their previous bus address to the derived bus address. Thereafter, the host IC can communicate with each target IC individually via its new, changed bus address.

In an alternative embodiment of the method according to the present disclosure, the host IC does not send a termination command to terminate the configuration mode KMOD (no step S3). In this alternative embodiment, after expiry of a fixed time period, which may be measured from receipt of the configuration command KONFB in step S1, the target ICs automatically leave the configuration mode KMOD and then in each case automatically change their previous default bus address to the individual bus address derived from the address message received in step S2.

In one possible embodiment, after the bus address change has been completed on the target ICs, the host IC can configure its GPIO pins as input pins. Furthermore, the target ICs can configure their INT pins to digital outputs directly toward the end of the KMOD configuration mode.

The method according to the present disclosure allows, after completion of the configuration, the assignment of unique addresses to a plurality of bus targets or a plurality of target ICs (T-ICs) which have the same initial default address before the configuration.

After completion of the configuration and modification of the bus addresses by means of the method according to the present disclosure, the additional connections (GPIO pin to INT pin) can be used again as interrupt lines or for other purposes for communication between target ICs and host IC.

In one possible embodiment, the bus address configurator of a target IC may be a digital circuit. The digital circuit may be implemented either as a dedicated digital logic circuit provided for this purpose or as firmware on an embedded microcontroller. A division of functions between the two implementation options is also possible. The bus address configurator of the target IC may be implemented either in digital hardware, as pure firmware, or as a combination of both.

The commands for starting and terminating the KMOD configuration mode do not extend the protocol of the serial interface. A simple write command to any address or the transmission of a specific command is sufficient. The command is preferably selected such that the target IC does not need to respond, so that no bus conflicts arise, since otherwise a plurality of target ICs would respond. In the case of I2C, it is possible for all target ICs to send the ACK bit simultaneously.

There is considerable flexibility in the design of the address message by means of which the host IC communicates its new bus address to a target IC.

The following exemplary embodiments for the design of the address message transmitted in step S2 of the method according to the present disclosure provide minimal and robust communication.

In one possible embodiment, in step S2 the host IC sends, from a GPIO pin via the control line, a defined number of falling (or rising) signal edges, as shown by way of example in FIG. 5. A counter implemented in the target IC counts the signal edges of the address message received via the control line. The host IC sends commands via the control lines to each target IC or encodes the new desired address for each target IC.

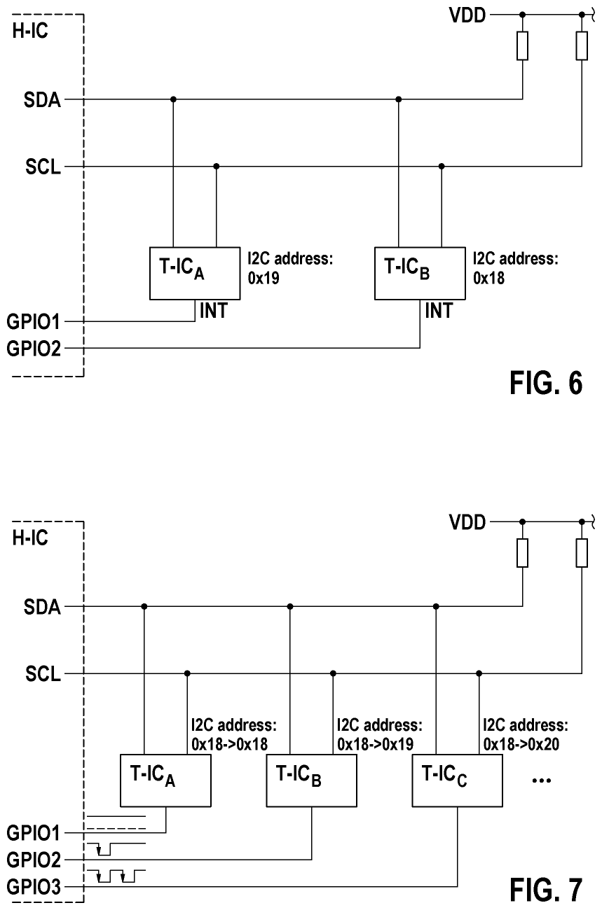

To obtain the new destination bus address, the target IC can either directly adopt the number of signal edges as the new bus address or add (or subtract) the number of signal edges to (or from) the previous default address, as illustrated by way of example in FIGS. 6, 7. The target ICs decode the new address, change it, and then the KMOD configuration mode is terminated. The target ICs now respond to the new addresses. In the exemplary embodiment shown in FIG. 7, the target ICs add the number of received pulses to the default address.

In another possible embodiment, the destination bus address may be transmitted directly, for example, using a Manchester code. With a known transmission rate or transmission speed, the destination bus address may be transmitted directly in binary form. The use of other codes is possible.

The Manchester code is a self-clocking binary code that encodes the clock signal and the data of a synchronous bitstream into a single signal. Unlike other coding techniques, Manchester coding uses the transition from a low to a high voltage level or from a high to a low level to represent the bit value, not the voltage level itself. The direction of the transition determines the state of a bit, not the signal level. For each individual symbol (bit), there is at least one transition. All relevant transitions occur in the middle of a bit, not at the beginning. In this way, one positive and one negative half-bit period represent one symbol. As a result, the length of each bit is fixed, and the Manchester code is thus self-clocking. This minimizes the error rate and optimizes reliability. The receiver can synchronize to the edges of the coded signal.

In a further alternative embodiment, the control line is used solely to select the target IC of which the address is to be changed at that time. For this purpose, the host IC drives all control lines to a predefined logical signal level (low or high), and only one control line to the selected target IC is driven to the inverse logical signal level. Thereafter, all other target ICs ignore any communication via the serial bus, and the host IC can conveniently transmit the new destination address to the target IC via the serial bus. In this embodiment, the INT pin functions essentially as a chip select during the configuration phase.

If an embedded microcontroller is provided in the target IC, the KONB configuration command may also include the download of a firmware image. This firmware then executes the change of the bus address according to the described process. In this embodiment, memory space in the target IC can be saved because this process does not need to be permanently stored in the target IC and its firmware.

If the target ICs each have a non-volatile memory that they can write to independently during operation, the method according to the present disclosure can, in one possible embodiment, be extended such that the above-described process only needs to be carried out once. At the end of the configuration phase, i.e. once all target ICs have received their new bus address, the target ICs can each store their new bus address locally in the non-volatile memory and thus use it as the new default address. On the next restart (for example, after a power-on reset), the target ICs can directly use their new default addresses and the host IC can start communicating immediately.

This reduces the overall startup time of the system during operation. It can also significantly simplify the host control, which is preferably implemented as firmware, if it does not have to take the configuration phase into account at all. This can be achieved by having the application manufacturer perform the configuration procedure once during manufacturing (optionally using a sequence of external commands or by means of volatile software), with the new bus addresses being stored, such that the target ICs in the final product no longer need to be reconfigured after every reset.

If no GPIO/interrupt pin is available in a target IC, a type of dynamic addressing method may also be used in an alternative embodiment, in which the propagation time of a signal is used to determine which target IC receives which address. However, this requires a complex printed circuit board layout that also takes component tolerances into account to ensure that such an addressing method operates reliably.

The method according to the present disclosure can be used, for example, in sensors. In this context, the sensors can communicate with a host IC as target ICs. For example, in one possible application, the sensors are inertial sensors.

Sensor ICs can generally inform the host IC about events related to the measured variable via interrupt pins. This occurs, for example, when a new current measured value is available. In the case of acceleration sensors, this also happens, for example, when specific movement patterns are detected. In many cases, sensor ICs thus already have interrupt pins, and therefore the addressing method according to the present disclosure is particularly suitable here. Furthermore, the interrupt connections of the sensor ICs are generally only needed during operation, not during the startup and configuration phase.

Some applications use two inertial sensors, for example for angle detection in a laptop or a foldable cell phone. Other applications have a plurality of inertial sensors. For example, VR gloves may comprise five inertial sensors.

Although the present disclosure has been completely described above with reference to preferred exemplary embodiments, it is not limited thereto, but can be modified in many ways.

What is claimed is:

1. A method for assigning unique addresses to target ICs that are connected via a common address-based serial bus to a host IC, wherein the host IC is connected to the target ICs via associated dedicated control lines, and wherein the target ICs have a common default bus address, the method comprising the following steps:
sending at least one configuration command by the host IC via the serial bus to the common default bus address, thereby placing the target ICs connected to the serial bus into a configuration mode; and
sending an address message by the host IC to a respective target IC of the target ICs in the configuration mode via the associated dedicated control line of the respective target IC, whereupon the respective target IC derives, from the address message, its own individual bus address, which replaces the default bus address for the target respective IC.

2. The method for assigning unique addresses to target ICs according to claim 1, wherein after the host IC sends the address message, a termination command is sent via the serial bus to the common default bus address to terminate the configuration mode, causing the target ICs connected to the serial bus to leave the configuration mode and causing the respective target IC to change the default bus address of the respective target IC to the individual bus address derived from the address message.

3. The method for assigning unique addresses to target ICs according to claim 1, wherein, after a predetermined time period following receipt of the configuration command by the respective target IC, the respective target IC is caused to automatically leave the configuration mode and change the default bus address of the target IC to the individual bus address derived from the address message.

4. The method for assigning unique addresses to target ICs according to claim 1, wherein the individual bus address derived from the address message is stored locally in a non-volatile memory of the respective target IC and is used as a default bus address of the respective target IC upon a restart.

5. The method for assigning unique addresses to target ICs according to claim 1, wherein the address message transmitted by the host IC to the respective target IC via the associated dedicated control line of the respective target IC has signal edges, a number of the signal edges being evaluated by the respective target IC in order to derive its individual bus address.

6. The method for assigning unique addresses to target ICs according to claim 1, wherein the address message transmitted by the host IC to the respective target IC via the associated dedicated control line of the respective target IC is transmitted using a Manchester code.

7. The method for assigning unique addresses to target ICs according to claim 1, wherein the target ICs connected to the serial bus are placed into a configuration mode by the host IC simultaneously or sequentially.

8. The method for assigning unique addresses to target ICs according to claim 1, wherein the host IC has a plurality of GPIO pins, which are connected to input pins of the target ICs via the associated dedicated control lines.

9. The method for assigning unique addresses to target ICs according to claim 8, wherein the host IC configures a respective GPIO pin of the GPIO pins as an output pin before sending the address message to the respective target IC via the associated dedicated control line, and wherein the host IC configures the respective GPIO pin as an input pin after changing the bus address of the respective target IC.

10. The method for assigning unique addresses to target ICs according to claim 1, wherein the target ICs connected to the serial bus each contain a bus address configurator which, after the configuration command is received by the respective target IC, is automatically activated to perform an address change of the bus address in accordance with the address message received via the associated dedicated control line of the respective target IC.

11. The method for assigning unique addresses to target ICs according to claim 1, wherein the associated dedicated control lines between the host IC and the target ICs are formed by interrupt lines.

12. A bus address configurator for configuring a unique bus address for a target IC connected to a host IC via an address-based serial bus and a dedicated control line, wherein the bus address configurator of the target IC is activated after receipt of at least one configuration command transmitted via the serial bus and changes a previous default bus address of the target IC to an individual bus address for the target IC, which is derived by the bus address configurator of the target IC from an address message received via the dedicated control line.

13. A target IC, comprising:
a bus address configurator for configuring a unique bus address for the target IC connected to a host IC via an address-based serial bus and a dedicated control line, wherein the bus address configurator of the target IC is activated after receipt of at least one configuration command transmitted via the serial bus and changes a previous default bus address of the target IC to an individual bus address for the target IC, which is derived by the bus address configurator of the target IC from an address message received via the dedicated control line; and
a non-volatile memory configured to store the changed individual bus address as a new default bus address of the target IC.

14. The target IC according to claim 13, wherein the target IC includes a sensor IC having at least one sensor unit.

15. The target IC according to claim 14, wherein the sensor IC is an inertial sensor IC.
